(19) United States
(12) Patent Application Publication
(10) Pub. No.: US 2007/0132820 A1
(43) Pub. Date: Jun. 14, 2007

(54) Liquid cartridge

(75) Inventor: Seiya Sato, Matsumoto-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/635,851

(22) Filed: Dec. 8, 2006

(30) Foreign Application Priority Data
Dec. 9, 2005 (JP) 2005-355954

(51) Int. Cl. B41J 2/175

(52) U.S. Cl. 347/86

(57) ABSTRACT

A liquid cartridge includes: a cartridge case including a case body having an opening at its one side and a lid member covering the opening of the case body; and a liquid accommodating part that is provided in an internal space defined within the cartridge case, at least a part of the liquid accommodating part being made of flexible material, wherein an air communicating path having one end communicating with an air introduction hole through which air is introduced and the other end communicating with the internal space is formed to surround the internal space in the cartridge case.

### BACKGROUND

1. Technical Field

The present invention relates to a liquid cartridge, and more specifically, to a liquid cartridge which is adapted to supply liquid to a liquid ejecting apparatus.

2. Related Art

In the related art, an inkjet type recording apparatus (hereinafter simply referred to as a recording apparatus) has been widely used as one kind of liquid ejecting apparatus having a liquid ejecting head from which liquid is ejected to a target. This recording apparatus, including a carriage and a recording head as the liquid ejecting head mounted on the carriage, performs a recording operation for a recording medium as a target by discharging ink as the liquid from a nozzle formed in the recording head while moving the carriage with respect to the recording medium.

In this recording apparatus, typically, ink to be discharged from the recording head is accommodated in an ink cartridge as a liquid cartridge. When the ink cartridge is mounted on the recording apparatus, air is introduced into the ink cartridge such that the ink received in the ink cartridge can be discharged externally. One of prior techniques related to an air introduction structure of the ink cartridge is disclosed in Patent Documents 1 and 2 listed below, for example.

Patent Document 1 discloses an inkjet printer in which a foam for absorbing and holding ink is received in an ink cartridge that supplies ink to a recording head while mounted on a carriage (which is called an On Carriage method), and air is introduced through an air opening formed on a top side of the ink cartridge.

Patent Document 2 discloses a liquid cartridge arranged in a body of a recording apparatus (which refers to a so-called Off Carriage method), in which an ink bag is received in the ink cartridge and pressurized air to press the ink bag is introduced into the ink cartridge so that ink accommodated in the ink bag can be supplied externally.

Patent Document 1: JP-A-2003-312005

Patent Document 2: JP-A-2005-59317

However, the structure disclosed in Patent Document 1 has a problem in that, since the foam is impregnated (absorbed and held) with ink, the quantity of ink which can be accommodated in the cartridge is reduced by the volume of the foam, thereby decreasing an ink volumetric efficiency, and an effective usage of ink is reduced since unused ink remains in the foam.

In the ink cartridge disclosed in Patent Document 2, ink is directly accommodated in the ink bag. Accordingly, the ink cartridge of Patent Document 2 has an ink volumetric efficiency better than the structure of Patent Document 1. However, in such a related art ink cartridge, an aluminum laminate film (comprising a resin layer and an aluminum gas barrier layer deposited on the resin layer) is commonly used in order to prevent viscosity of the ink accommodated in the ink bag from being raised and keep a degree of degassing constant. For this account, the ink bag is restricted to a shape to which pressurized force can be effectively applied (that is, a shape such that the ink bag can easily deform). This may cause a problem of lowering of an ink volumetric efficiency due to an empty space occurring inside the ink cartridge receiving the ink bag. In other words, when the ink bag has the same shape as the inner space of the ink cartridge, a negative pressure is increased as residual quantity of ink is decreased, and accordingly, the ink accommodated in the ink bag may not be exhausted.

### SUMMARY

An advantage of some aspects of the invention is to provide a liquid cartridge which can improve volumetric efficiency of a liquid while preventing viscosity of the liquid from being raised and keeping a degree of degassing constant.

The advantage can be attained as at least one of the following aspects:

A first aspect of the invention provides a liquid cartridge comprising: a cartridge case comprising a box-shaped case body with one side opened and a lid member covering an opening of the case body; and a liquid accommodating part that is provided in an internal space defined within the cartridge case, at least a part of the liquid accommodating part being made of flexible material. An air communicating path having one end communicating with an air introduction hole through which air is introduced and the other end communicating with the internal space is formed to surround the internal space in the cartridge case.

With this configuration, since the air communicating path communicating the internal space within the cartridge case with atmosphere is formed to surround the internal space, water accommodated in the liquid accommodating part can be prevented from being evaporated, thereby allowing viscosity of the liquid to be effectively prevented from being raised, compared to a configuration where the air is directly introduced from the air introduction hole into the internal space. In addition, it can be effectively prevented that a degree of degassing is lowered due to bubbles produced in the ink pack. Accordingly, it is possible to form the liquid accommodating part (all or some) made of flexible material (for example, resin film or rubber) without using an aluminum laminate film to prevent viscosity of the liquid from being raised and keep a degree of degassing constant. Accordingly, it is possible to accommodate the liquid of the substantially same volume as the internal space in the liquid accommodating part, which results in improvement of an ink volumetric efficiency. That is, in this configuration, since the liquid accommodating part can be formed by deformable material (in other words, material apt to be pressed down by the introduced air), a negative pressure can be suppressed from being raised when the amount of liquid remaining in the liquid accommodating part is reduced, thereby allowing exhaustion of the liquid.

Preferably, the air communicating path is formed by sealing a shallow groove with the lid member, the shallow groove being formed on an edge of the opening at a top side of side walls of the case body.

With this configuration, the air communicating path is formed by sealing an opening of a shallow groove formed on an edge of the opening of the case body with the lid member. That is, the air introduced from the air introduction hole is introduced into the internal space after going around the internal space via the air communicating path. Accordingly, viscosity of liquid in the liquid accommodating part can be prevented from being raised and a degree of degassing can remain constant.

Preferably, the case body includes an external case forming side walls of the case body and an internal case formed in an inner side of the external case at a predetermined interval and defining the internal space, and the air communicating path is formed by sealing an opening of a groove having a U-shaped section with the lid member, the groove being defined by the external case and the internal case in a substantially annular shape at a periphery of the case body.

With this configuration, the air communicating path is formed by sealing an opening of a groove defined by the external case and the internal case in a substantially annular shape at a periphery of the case body with the lid member. That is, the air introduced from the air introduction hole is introduced into the internal space after going around the internal space (the periphery of the case body) via the air communicating path. Accordingly, viscosity of liquid in the liquid accommodating part can be prevented from being raised and a degree of degassing can remain constant.

Preferably, a seal member covering the air introduction hole is attached to the case body, and the seal member by be broken when the liquid cartridge is mounted.

With this configuration, the air communicating path, i.e., the internal space, can be shielded from the outside in a preserved condition of the liquid cartridge (that is, before the liquid cartridge is mounted). Accordingly, even in the preserved condition of the liquid cartridge, viscosity of liquid can be prevented from being raised and a degree of degassing can remain constant.

Preferably, the liquid accommodating part is a bag-shaped flexible liquid pack having the substantially same shape as the internal space.

With this configuration, since the liquid pack is formed to have the substantially same shape as the internal space, the liquid pack can be filled with liquid having the substantially same volume as the internal space.

Preferably, the liquid pack is made of a resin film or rubber.

With this configuration, since the liquid pack is made of a flexible resin film or rubber, a negative pressure can be suppressed from being raised when the amount of liquid remaining in the liquid pack is reduced.

Preferably, the liquid accommodating part is a liquid container including a wall part of the case body and a resin film attached to the wall part, the wall part being formed in a substantially annular shape in an inner side of the internal space, the liquid container is formed with the substantially same shape as the internal space, and a space communicating with the internal space and the air communicating path is defined between the resin film covering one side of the liquid container and the lid member.

With this configuration, since the liquid container is formed to have the substantially same shape as the internal space, the liquid container can be filled with liquid having the substantially same volume as the internal space. In addition, since one side of the liquid container is covered by a flexible resin film, and a space communicating with the internal space and the air communicating path is defined between the resin film and the lid member, the resin film is pressed down by the air introduced through the air communicating path, and accordingly, the liquid accommodated in the liquid container may be exhausted.

A second aspect of the invention provides a liquid cartridge comprising: outer walls including a front wall, a rear wall and side walls, all of which extend upright from a bottom plate; a lid member covering an opening which is defined by the front wall, the rear wall and side walls and opposed to the bottom plate; inner walls disposed within an inside of the outer walls and defining a internal space for accommodating liquid therein, wherein a gap defined between the outer walls and the inner walls communicates an air introduction hole with the internal space.

A third aspect of the invention provides a liquid cartridge comprising: outer walls including a front wall, a rear wall and side walls, all of which extend upright from a bottom plate to define a internal space for accommodating liquid therein; a lid member covering an opening which is defined by the front wall, the rear wall and side walls and opposed to the bottom plate; and a groove formed on a top side of the outer walls and communicating an air introduction hole with the internal space.

According to the second and third aspects of the invention, the same advantage as the first aspect can be attained

The present disclosure relates to the subject matter contained in Japanese patent application No. 2005-355954 filed on Dec. 9, 2005, which is expressly incorporated herein by reference in its entirety.

### BRIEF DESCRIPTION OF THE DRAWINGS

The invention will be described with reference to the accompanying drawings, wherein like numbers reference like elements.

FIG. 1 is an exploded perspective view of an ink cartridge according to a first embodiment.

FIG. 2 is a partially exploded plan view of the ink cartridge according to the first embodiment.

FIG. 3 is a perspective view of an inkjet type recording apparatus with the ink cartridge according to the first embodiment mounted thereon.

FIG. 4 is an exploded perspective view of the inkjet type recording apparatus shown in FIG. 3.

FIG. 5 is an exploded perspective view of an ink cartridge according to a second embodiment.

FIG. 6 is a partially exploded plan view of the ink cartridge according to the second embodiment.

### DESCRIPTION OF EXEMPLARY EMBODIMENTS

### First Embodiment

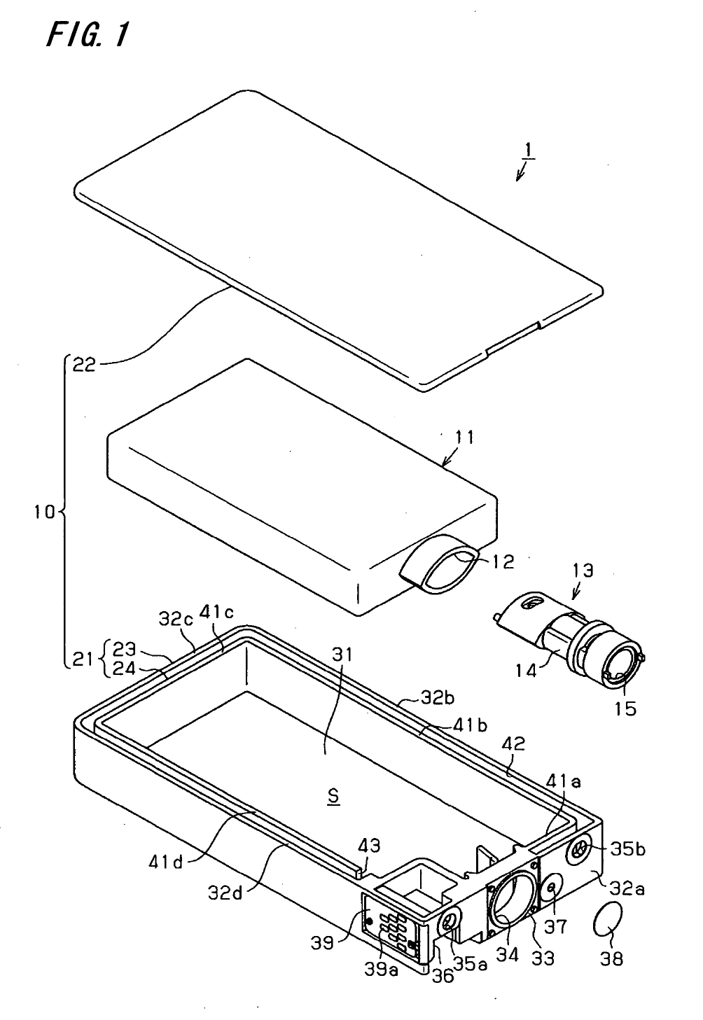

Hereinafter, an inkjet cartridge for supplying ink to a recording head of an inkjet type recording apparatus, for example, according to a first embodiment of the present invention will be described with reference to FIGS. 1 to 4. In this embodiment, the liquid cartridge will be illustrated with an ink cartridge, however, may be a liquid cartridge used for liquid ejecting apparatuses that eject liquid other than ink. For example, the liquid cartridge may be a liquid cartridge used for a liquid ejecting apparatus that ejects electrode material (conductive paste) or color material used to manufacture a liquid crystal display, an organic electro-luminescence (EL) display, a field emission display (FED) and soon, a liquid ejecting apparatus that ejects bio organic matter used to manufacture a biochip, or a precision pipette sample ejecting apparatus, and so on.

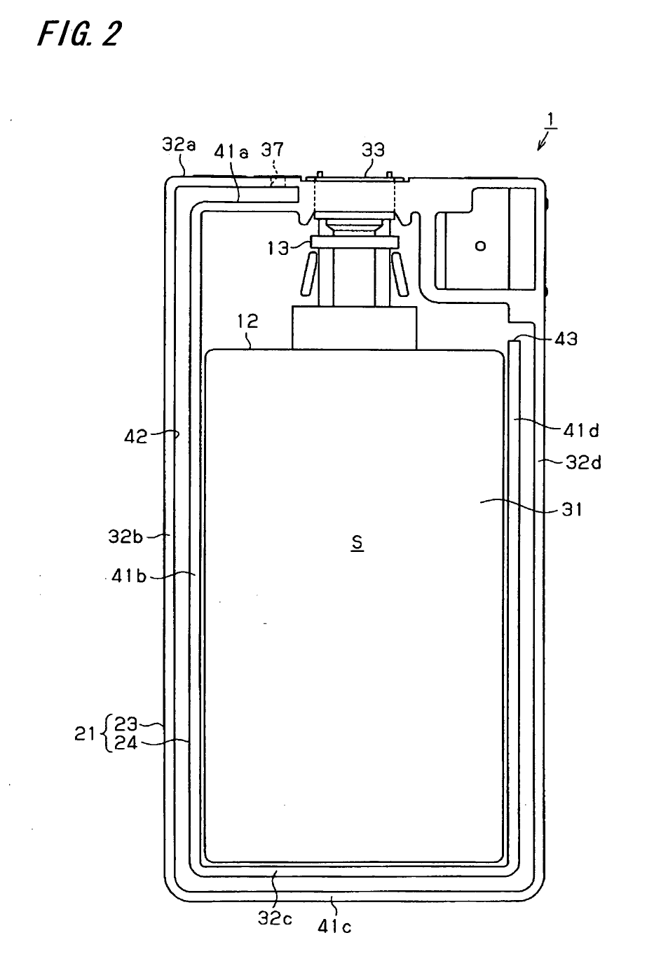

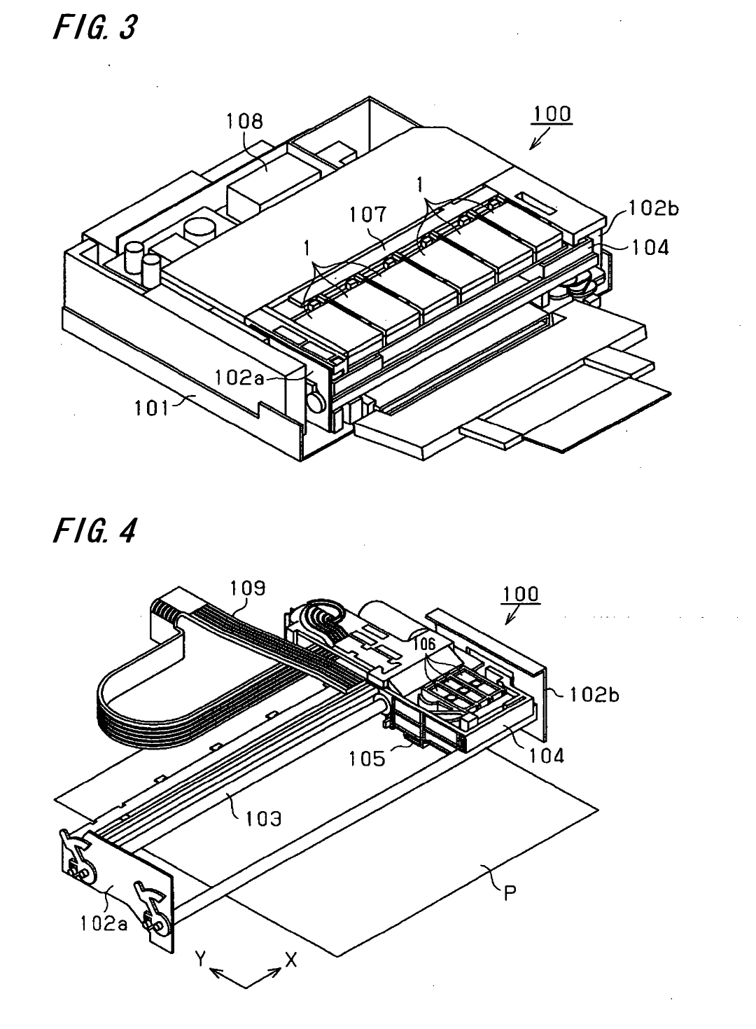

FIG. 1 is an exploded perspective view of an ink cartridge 1 of the first embodiment, FIG. 2 is a plan view showing the internal of the ink cartridge 1, and FIGS. 3 and 4 are perspective views of an inkjet type recording apparatus (hereinafter simply referred to as a recording apparatus) 100 with the ink cartridge 1 mounted thereon.

First, the ink cartridge 1 will be described.

As shown in FIG. 1, the ink cartridge 1 comprises a box-shaped cartridge case 10 and an ink pack 11 as a liquid pack (liquid accommodating part) that is air-tightly received in the cartridge case 10.

The ink pack 11 is made of flexible material, for example, a resin film such as polyethylene (PE), polyethyleneterephthalate (PET), ethylene-vinyalcohol resin (EVOH) or the like or a rubber. The ink pack 11 is formed in a shape of bag and accommodates ink as liquid therein. The ink pack 11 has the substantially same shape as an internal space S defined within the cartridge case 10, which will be described later. The ink pack 11 can be filled with ink until the ink pack 11 has the substantially same volume as the internal space S. An opening 12 is provided at a front end of the ink pack 11. An ink delivery part 13 to draw the ink out of the ink pack 11 is attached as a liquid delivery part to the opening 12.

The ink delivery part 13 is provided with an ink supply valve (not shown) having a check valve inside a tube 14 made of resin or the like. With the ink delivery part 13 communicating with the inside of the ink pack 11, the circumference of a base end of the ink delivery part 13 is thermally adhered to the opening 12 of the ink pack 11. In addition, when a hollow ink supply needle (not shown) provided in the recording apparatus 100 is inserted into an ink drawing-out hole 15 of the ink delivery part 13, the ink supply valve is opened, and accordingly the ink in the ink pack 11 is externally led through the ink drawing-out hole 15.

The cartridge case 10 comprises a box-shaped case body 21 with its top side opened and a rectangular lid member 22 covering the opening of the case body 21, both of which are made of synthetic resin (for example, polypropylene). With the case body 21 covered by the lid member 21, the lid member 22 is thermally adhered to the case body 21.

The case body 21 has a double structure having an external case 23 forming an outer wall of the case body 21 and an internal case 24, which is smaller than the external case 23, forming an inner wall of the case body 21. The internal space S receiving the ink pack 11 is defined by the internal case 24.

Specifically, the external case 23 comprises a bottom wall 31 having a rectangular shape (the same shape as the lid member 22), and four side walls 32a, 32b, 32c and 32d.

In the center of the side wall 32a of the external case 23 is provided a square bracket 33 having a circular opening 34 formed at its center. In addition, the ink delivery part 13 is inserted in the opening 34 from the inside of the cartridge case 10.

At both ends of the side wall 32a are respectively positioning holes 35a and 35b. The positioning holes 35a and 35b correspond to a pair of positioning projections (not shown) formed in a cartridge holder 107 (see FIG. 3) of the recording apparatus 100, respectively. When the ink cartridge 1 is mounted on the cartridge holder 107, the positioning holes 35a and 35b and the positioning projections are fixed with each other in position.

In addition, an engagement part 36 is formed below the positioning hole 35a formed in the left of the side wall 32a. An engagement lever (not shown) formed in the cartridge holder 107 of the recording apparatus 100 is engaged with the engagement part 36 when the ink cartridge 1 is mounted on the cartridge holder 107.

In addition, an air introduction hole 37 is formed at a lower portion below the positioning hole 35b formed in the right of the side wall 32a. The air introduction hole 37 is a hole for communicating the inside of the cartridge case 10 to its outside. That is, the air introduction hole 37 opens the internal space S of the cartridge case 10 to atmosphere (in this embodiment, pressurized air is introduced into the internal space S through the air introduction hole 37). The air introduction hole 37 is sealed by a seal member 38 attached to the sidewall 32a in a preserved condition of the ink cartridge 1 (that is, before the ink cartridge 1 is mounted on the recording apparatus 100). When the ink cartridge 1 is mounted on the recording apparatus 100, the seal member 38 is broken by a member (air supply needle) of the recording apparatus 100, which will be described later, thereby communicating the inside of the cartridge case 10 to atmosphere. That is, when the ink cartridge 1 is mounted on the recording apparatus 1, the inside of the cartridge case remains airtight.

In addition, a circuit board 39 having a semiconductor memory device mounted thereon is fixed on the side wall 32d joined to the side wall 32a at a side of the engagement part 36. In the semiconductor device, in addition to information on the kind of the ink cartridge and information on color of ink held in the ink cartridge 1, information on the remaining amount of ink, etc is stored. This information is exchanged between the circuit board 39 and the recording apparatus 100 through a plurality of terminals 39a exposed on a surface of the circuit board 39.

The internal case 24 has a substantially annular shape and comprises four side walls 41a, 41b, 41c and 41d that are installed upright on the bottom wall 31 of the external case 23 and are separated by a predetermined interval from the side walls 32a, 32b, 32c and 32d, respectively.

As shown in FIG. 2, the side wall 41a of the internal case 24 is connected to the side wall 32a of the external case 23 between the air introduction hole 37 and the square bracket 33. In addition, the side wall 41a is formed with a groove having a U-shaped section by the side wall 32a and the bottom wall 31. Likewise, the side walls 41b, 41c and 41d are formed with grooves having a U-shaped section by the side walls 32b, 32c and 32d of the external case 23 and the bottom wall 31, respectively. That is, grooves having a U-shaped section are meanderingly (circuitously) formed around the case body 21 to surround the internal space S. In addition, as openings of the grooves formed around the case body 21 are sealed by the lid member 22 fixed to the case body 21, an air communicating path 42 is formed to surround the internal space S in the case body 21.

One end of the air communicating path 42 communicates with the air introduction hole 37. The other end (each of ends of the side walls 32d and 41d) of the air communicating path 42 forms an opening 43 communicating with the internal space S. Accordingly, air introduced into the air communicating path 42 through the air introduction hole 37 is introduced from the opening 43 into the internal space S through the air communicating path 42.

Next, an example of a configuration of the recording apparatus 100 on which the above-configured ink cartridge 1 is mounted will be described with reference to FIGS. 3 and 4.

As shown in FIG. 3, the recording apparatus 100 has a box-shaped case 101. At both opposite sides of the case 101 is provided a pair of opposite frames 102a and 102b. A bar-shaped guide shaft 103 (see FIG. 4) is provided between both frames 102a and 102b. A carriage 104 is movably inserted and held in the guide shaft 103. The carriage 104 reciprocates in a longitudinal direction (a main scan direction X shown in FIG. 4) of the guide shaft 103 by a driving force of a carriage motor (not shown) provided in the recording apparatus 100.

As shown in FIG. 4, a recording head 105 is mounted on a bottom side of the carriage 104. The recording head 105 is formed with a plurality of ejecting nozzles (not shown) for ejecting ink. In addition, on a top side of the carriage 104 is mounted a plurality of valve units 106 for supplying pressure-adjusted ink to the recording head 105. In this embodiment, for example, three valve units 106 are mounted on the top side of the carriage 104, and the recording head 105 may be supplied with ink having six colors (black, yellow, magenta, cyan, light magenta and light cyan) made by adjusting pressure of ink having two colors.

Between both frames 102a and 102b, a platen (not shown) comprising a paper feed means is arranged in parallel to the guide shaft 103 below a region within the carriage 104 moves. The platen feeds a recording medium P as a target in a sub scan direction Y perpendicular to the main scan direction X. As ink droplets are discharged from the ejecting nozzles of the recording head 105 onto the recording medium P fed in the sub scan direction Y, a recoding operation for the recording medium P is performed.

In addition, as shown in FIG. 3, between both frames 102a and 102b of the case 101, the cartridge holder 107 is fixed above the region within which the carriage 104 moves. The ink cartridge 1 is mounted on the cartridge holder 107. FIG. 3 also shows six ink cartridges 1 mounted on the cartridge holder 107.

A booster pump 108 is disposed at a rear side of the case 101. In addition, a strip-shaped chained passage 109 made of flexible material that interconnects the valve units 106 and the cartridge holder 107 is arranged around a disposition location of the booster pump 108 in the case 101 (see FIG. 4). The chained passage 109 comprises a chain of six ink passages (not shown) and six air passages (not shown). The ink passages supply ink in the ink cartridge 1 (ink pack 11) to respective valve units 106. The air passages supply pressurized air, which is discharged from the booster pump 108, from air introduction holes 37 of respective ink cartridges 1 to the air communicating path 42 through a hollow air supply needle (not shown) provided in the cartridge holder 107.

The above-configured ink cartridge 1 is mounted on the cartridge holder 107, with the ink pack 11 filled with ink. At this time, the ink pack 11 is filled with ink of the substantially same volume as the internal space S defined by the case body 21 and the lid member 22 of the cartridge case 10 (specifically, a space surrounded by the bottom wall 31 of the external case 23, the side walls 41a, 41b, 41c and 41d, and the lid member 22). Such the filling is possible because the ink pack 11 is made of flexible material.

When the ink cartridge 1 is mounted on the cartridge holder 107, the ink supply needle (not shown) of the cartridge holder 107 is inserted into the ink drawing-out hole 15 of the ink delivery part 13. Accordingly, the valve of the ink delivery part 13 is opened to make it possible to supply the ink in the ink pack 11 to the recording apparatus 100. In addition, when the ink cartridge 1 is mounted on the cartridge holder 107, the air supply needle (not shown) of the cartridge holder 107 breaks the seal member 38 and is inserted from the air introduction hole 37 into the air communicating path 42. Accordingly, it is possible to supply the pressurized air into the internal space S within the cartridge case 10 through the air communicating path 42.

Under this condition, when the recording apparatus 100 starts a recording operation, air pressurized in the booster pump 108 (pressurized air) is introduced from the air introduction hole 37 into the air communicating path 42. Then, the pressurized air is introduced from the air communicating path 42 surrounding the internal space S at a periphery of the case body 21 into the internal space S through the opening 43. As a result, the internal pressure of the internal space S rises, and accordingly a force to press down the ink pack 11 (pressing force) is applied to the ink pack 11. Accordingly, the ink in the ink pack 11 is supplied from the ink delivery part 13 into the recording apparatus through the ink supply needle.

Thus, the ink supplied into the recording apparatus 100 is once stored in the valve units 106 of the recording apparatus 100, and then is supplied into the recording head 105 with a pressure of the ink adjusted. Then, the recording apparatus 100 performs a recording operation for the recording medium P by ejecting the ink from the recording head 105 while moving the recoding medium P in the sub scan direction Y by means of the paper feeding means and moving the carriage 104 in the main scan direction X.

As described above, the first embodiment has the following effects.

(1) The air communicating path communicating the internal space S within the cartridge case 10 with atmosphere is formed to surround the internal space S defined by the case body 21 and the lid member 22 at the periphery of the case body 21. This configuration allows water contained in the ink pack 11 to be prevented from being evaporated, thereby allowing viscosity of the ink to be effectively prevented from being raised, compared to a configuration where the pressurized air is directly introduced from the air introduction hole 37 into the internal space S. In addition, it can be effectively prevented that a degree of degassing is lowered due to bubbles produced in the ink pack 11. Accordingly, it is possible to form the ink pack 11 made of flexible material (for example, resin film or rubber) without using an aluminum laminate film to prevent viscosity of the ink from being raised and keep a degree of degassing constant. Accordingly, it is possible to accommodate ink of the substantially same volume as the internal space S in the ink pack 11, which results in improvement of an ink volumetric efficiency. That is, in this embodiment, since the ink pack 11 can be formed by deformable material (in other words, material apt to be pressed by the pressurized air), a negative pressure is suppressed from being raised when the remaining amount of ink is reduced, thereby allowing exhaustion of the ink.

(2) In this embodiment, it is configured that the seal member 38 covering the air introduction hole 37 is attached to the case body 21 and the air communicating path 42 communicates with atmosphere (allowing the pressurized air to be introduced into the air communicating path 42) by breaking the seal member 38 when the ink cartridge 1 is mounted on the recording apparatus 100. With this configuration, the air communicating path 42, i.e., the internal space S, can be shielded from the outside in a preserved condition of the ink cartridge 1 (that is, before the ink cartridge 1 is mounted on the recording apparatus 100). Accordingly, it is possible to prevent the viscosity of ink from being raised and keep the degree of degassing constant in the preserved condition of the ink cartridge 1.

### Second Embodiment

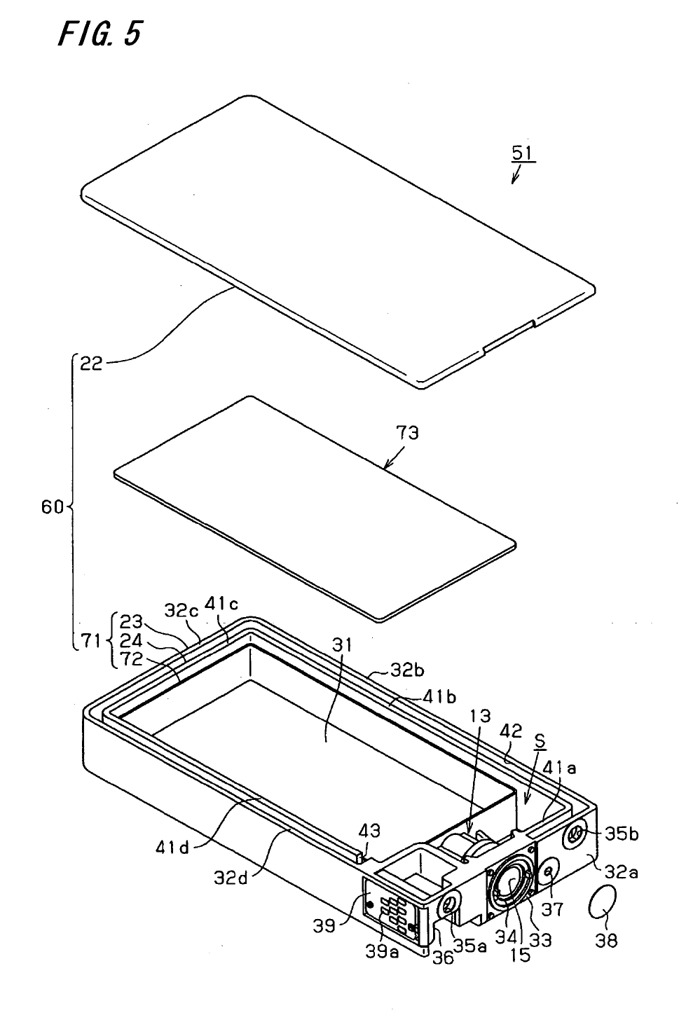

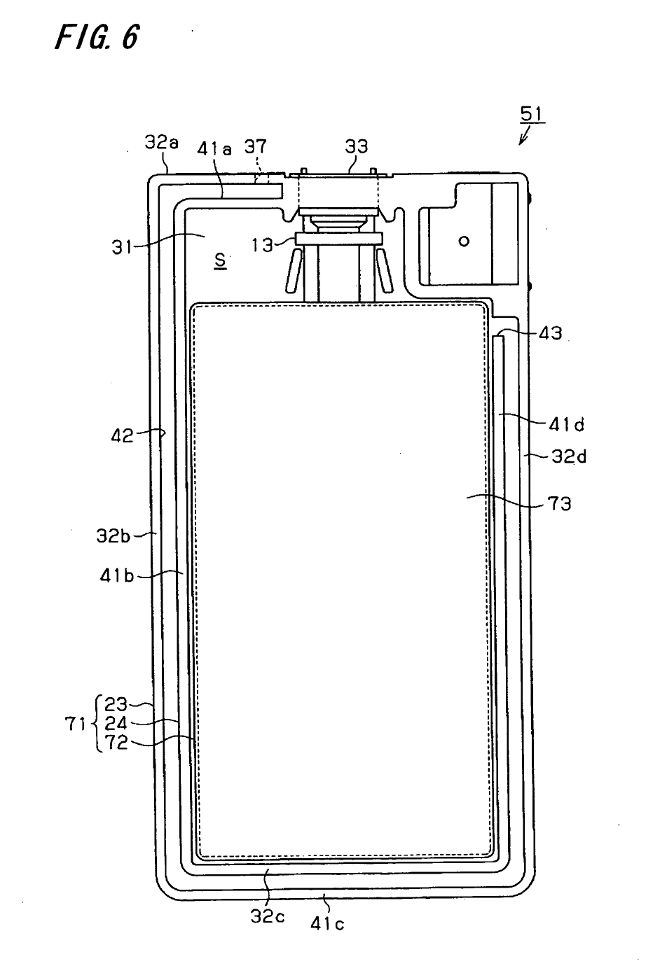

Next, a second embodiment of the present invention will be described with reference to FIGS. 5 and 6, with focused on differences from the first embodiment. The second embodiment has the same configuration as the first embodiment except a configuration of the liquid accommodating part of the ink cartridge. Therefore, the same elements as in the first embodiment are denoted by the same reference numerals and detailed description thereof will be omitted.

FIG. 5 is an exploded perspective view of the ink cartridge 51 according to the second embodiment and FIG. 6 is a plan view showing the interior of the ink cartridge 51.

As shown in FIG. 5, the ink cartridge 51 has a box-shaped cartridge case 60. Similarly to the first embodiment, the cartridge case 60 comprises a box-shaped case body 71 with its top side opened and a rectangular lid member 22 covering the opening of the case body 71, both of which are made of synthetic resin (for example, polypropylene). With the case body 71 covered by the lid member 71, the lid member 22 is thermally adhered to the case body 71.

The case body 71 has a triple structure having an external case 23 forming an outer wall of the case body 71, an internal case 24 which is smaller than the external case 23, and a substantially annular shape wall part 72 which is provided within the internal case 24 and smaller than the internal case 24. The external case 23 and the internal case 24 have the same shape as in the first embodiment.

As shown in FIGS. 5 and 6, the wall part 72 stands on a bottom wall 31 of the external case 23 at an inner side of an internal space S (a space surrounded by the bottom wall 31 and side walls 41a, 41b, 41c and 41d) of the internal case 24). On the wall part 72 is attached a flat resin film 73 made of flexible material (the same material (PE, PET, EVOH or the like) as in the first embodiment). In the second embodiment, a liquid container (liquid accommodating part) for accommodating ink is formed by the bottom wall 31, the wall part 72 and the resin film 73. The liquid container has the substantially same shape as the internal space S.

The resin film 73 is beforehand deformed into the shape of the case body 71, specifically, the shape of the liquid container (ink injection space) formed by the bottom wall 31 of the case body 71 and the wall part 72, and then is thermally adhered to the wall part 72 using a vacuum forming method. Accordingly, it is possible to deform the flat resin film 73 into the shape of the liquid container even by a small ink absorption force. Here, the vacuum forming method is a process of preheating the resin film 73, adhering the preheated resin film 73 to a mould such that the resin film 73 has a predetermined shape such as a projection and recess.

The wall part 72 is formed to be lower than the side walls 41a, 41b, 41c and 41d of the internal case 24. Accordingly, a space communicating with the internal space S and the air communicating path 42 is defined between the resin film 73 covering one side of the liquid container and the lid member 22 fixed to the case body 71. Thus, the pressurized air introduced from the air introduction hole 37 into the air communicating path 42 is introduced from the air communicating path 42 into the space (between the resin film 73 and the lid member 22) through the opening 43. As a result, the internal pressure of the internal space S is raised, the resin film 73 is pressed by the pressurized air, and accordingly, the ink in the liquid container is externally led through the ink delivery part 13. In this manner, the second embodiment employing the liquid container (liquid accommodating part) having its one side covered by the resin film 73 has the same effect as the first embodiment.

Hereinafter, modifications of the above-described embodiments will be described.

(Modification 1)

In the above-described embodiments, the air communicating path 32 is formed with the double wall structure including the external case 23 and the internal case 24. However, the spirit of the present invention is limited to this double wall structure. For example, only the external case 23 may be formed without forming the internal case 24 (that is, without employing the double wall structure), and a concave shallow groove communicating with the air introduction hole 37 and the internal space S may be formed on top sides of the side walls 32a, 32b, 32c and 32d of the external case 23 (that is, an edge of the opening of the case body 21 and 71). In addition, the air communicating path 42 is formed by covering a top opening of the shallow groove with the lid member 22. Even with this configuration, the air introduced from the air introduction hole 37 is introduced into the internal space S after going around the internal space S via the air communicating path 42. Accordingly, as in the above embodiments, modification 1 also has an effect that viscosity of liquid is prevented from being raised and a degree of degassing remains constant.

(Modification 2)

Although it is configured in the above embodiments that the pressurized air (air pressurized in the booster pump 108) is introduced from the air introduction hole 37, air which is not pressurized may be, as it is, introduced from the air introduction hole 37.

(Modification 3)

Although it is configured in the above embodiments that the air communicating path 42 is formed to have the substantially annular shape at the periphery of the case body 21 and 71, the air communicating path 42 may be formed to have a shape more complicated than the substantially annular shape in consideration of a shape of a region (groove) defined by the external case 23 and the internal case 24.

What is claimed is:

1. A liquid cartridge comprising:
a cartridge case including a case body having an opening at its one side and a lid member covering the opening of the case body; and
a liquid accommodating part that is provided in an internal space defined within the cartridge case, at least a part of the liquid accommodating part being made of flexible material,
wherein an air communicating path having one end communicating with an air introduction hole through which air is introduced and the other end communicating with the internal space is formed to surround the internal space in the cartridge case.

2. The liquid cartridge according to claim 1, wherein the air communicating path is formed by sealing a shallow groove with the lid member, the shallow groove being formed on an edge of the opening at a top side of side walls of the case body.

3. The liquid cartridge according to claim 1, wherein the case body includes: an external case forming side walls of the case body; and an internal case formed at an inner side of the external case with a predetermined interval and defining the internal space, and
wherein the air communicating path is formed by sealing an opening of a groove having a U-shaped section with the lid member, the groove being defined by the external case and the internal case in a substantially annular shape at a periphery of the case body.

4. The liquid cartridge according to claim 1, further comprising
a seal member attached to the case body and covering the air introduction hole, wherein the seal member is broken when the liquid cartridge is mounted.

5. The liquid cartridge according to claim 1, wherein the liquid accommodating part is a bag-shaped flexible liquid pack having the substantially same shape as the internal space.

6. The liquid cartridge according to claim 5, wherein the liquid pack is made of a resin film or rubber.

7. The liquid cartridge according to claim 1, wherein the liquid accommodating part is a liquid container including a wall part of the case body formed in a substantially-annular shape in an inner side of the internal space and a resin film attached to the wall part,
the liquid container is formed to have the substantially same shape as the internal space, and
a space communicating the internal space and the air communicating path with each other is defined between the resin film covering one side of the liquid container and the lid member.

8. A liquid cartridge comprising:
outer walls including a front wall, a rear wall and side walls, all of which extend upright from a bottom plate;
a lid member covering an opening which is defined by the front wall, the rear wall and side walls and opposed to the bottom plate;
inner walls disposed within an inside of the outer walls and defining a internal space for accommodating liquid therein,
wherein a gap defined between the outer walls and the inner walls communicates an air introduction hole with the internal space.

9. A liquid cartridge comprising:
outer walls including a front wall, a rear wall and side walls, all of which extend upright from a bottom plate to define a internal space for accommodating liquid therein;
a lid member covering an opening which is defined by the front wall, the rear wall and side walls and opposed to the bottom plate; and
a groove formed on a top side of the outer walls and communicating an air introduction hole with the internal space.
